(19) United States
(12) Patent Application Publication
(10) Pub. No.: US 2002/0068599 A1
(43) Pub. Date: Jun. 6, 2002

(54) System and method for dynamic local phone directory

(75) Inventors: Herman Rodriguez, Austin, TX (US); Newton James Smith JR., Austin, TX (US); Clifford Jay Spinac, Austin, TX (US)

Correspondence Address: Joseph T. Van Leeuwen, P.O. Box 81641, Austin, TX, 78708-1641, US

(73) Assignee: International Business Machines Corporation

(21) Appl. No.: 09/730,419

(22) Filed: Dec. 4, 2000

(51) Int. Cl. H04Q 7/20; H04M 1/00; H04B 1/38

(52) U.S. Cl. 455/550; 455/564

(57) ABSTRACT

A system and method for providing a local telephone directory based on a mobile telephone location is provided. When the mobile telephone moves from one mobile telephone area, such as a cell, to another area, new local telephone information is received from the mobile telephone company. The mobile telephone receives the local telephone information and stores the information in a dynamic directory storage area. The user can enter preferences such as a preferred language, that is used to identify local numbers. Dynamic speed dial keys may also be assigned so that, for example, the local police station is always assigned to the same speed dial key even though the local police station phone number changes as the mobile phone moves from one area to another. The filtering of data can be performed at either the mobile telephone company or on the mobile telephone after receiving the local directory information.

### RELATED APPLICATIONS

This application is related to the following co-pending U.S. patent applications having the same inventors and assignee as the present invention: “Method and System for Transferring and Receiving Directory Information To and From Electronic Communication Devices” (Ser. No. 09/661,454) and “Hierarchical organization of Directory Entries Within Electronic Communication Devices” (Ser. No. 09/660,958) each filed on Sep. 13, 2000.

### BACKGROUND OF THE INVENTION

1. Technical Field

The present invention relates in general to a method and system for providing a dynamic directory. More particularly, the present invention relates to a system and method for providing a dynamic local phone directory based on a location of a mobile phone.

2. Description of the Related Art

Mobile telephones are available to perform a wide variety of tasks. Semiconductor technology has enabled mobile telephone devices to better assist people in their daily activities. Mobile telephones, for example, can not only be used to place telephone calls but can also be used to access the Internet, send and receive email, check stock quotes and sports scores, and act as a personal digital assistant (or PDA).

Mobile telephones connect to a telephone network using a wireless connection. Because of their usefulness, users often store frequently used phone numbers in electronic directories within the mobile telephone. Because of their portability, users frequently carry mobile telephones with them throughout their day. In this manner, functions within the mobile telephone are available to the user throughout the day.

Mobile telephones are especially useful while the user is traveling. While traveling, the user has continual access to functions provided by the mobile telephone, including the ability to place calls on the mobile telephone. The user can place telephone calls even though he may be miles away from a traditional wired telephone connected to the public switched telephone network.

Mobile telephone systems use various technologies to provide a wireless connection between the user's mobile telephone and the telephone network. Cellular technology is one technology used in mobile telephone systems. A cell phone is a mobile telephone that connects to a cellular network. A cellular telephone is a duplex device that uses one frequency for talking and a second, separate frequency for listening. A CB radio has 40 channels whereas a cell phone can communicate on 1,664 channels. Cell phones operate within “cells,” and they can switch cells as they move around. Cells give cell phones a large range. A walkie-talkie can transmit perhaps a mile. A CB radio, because it has much higher power, can transmit perhaps five miles. Someone using a cell phone, on the other hand, can drive across a city and maintain a conversation the entire time. AMPS (Advanced Mobile Phone System) is the cell phone standard.

Cellular systems divide regions, such as a city, into small cells. This allows extensive frequency reuse across a city so that millions of people can use cell phones simultaneously. The carrier divides an area (such as a city) into cells. Each cell is typically sized at about 10 square miles (perhaps 3 mi×3 mi).

The power consumption of the cell phone, which is normally battery-operated, is relatively low. Low power allows cell phones to use small batteries, thus increasing the portability of the phones.

The transmissions of a base station and the phones within its cell do not radiate very far outside the cell. Therefore, the same frequencies can be used in other cells, so that frequencies can be reused extensively across the city.

The cellular approach requires a large number of base stations in a city of any size. A typical large city can have hundreds of towers. Because so many people are using cell phones, costs remain fairly low per user. Each carrier in each city also runs one central office called the MTSO (Mobile Telephone Switching Office). This office handles all of the phone connections to the normal land-based phone system and controls all of the base stations in the region.

When a call is placed to a cell phone, the MTSO gets the call, and it tries to find the cell phone. In early (pre-roaming) systems the MTSO found the receiver by paging the phone (using one of the control channels, to which the phone is always listening) in each cell of the region until the phone responded. It then notified both the receiving phone and the base station in the cell which of the channels in the cell the phone should use. At that point the receiving phone was connected to the base station, and a conversation could commence between the caller and receiver.

As a cell phone user moves toward the edge of a cell, the cell's base station notes that the signal strength from the cell phone is diminishing. Meanwhile, the base station in the cell the user is moving toward (which is listening and measuring signal strength on all frequencies) determines that the phone's signal strength is increasing. The two base stations are coordinated through the MTSO, and at some point the cell phone gets a signal on a control channel telling it to change frequencies. This handoff switches the phone to the new cell.

Roaming alters the way phones work in a cellular system. In modern systems, cell phones listen for a System ID (SID) on the control channel at power-up. If the SID on the control channel does not match the SID programmed into the phone, then the phone determines that it is “roaming.” Roaming means that the phone is not operating in the phone's local network and therefore is operating, either in analog or digital mode, in another local network. Local networks can be divided on a geographic basis and can also be divided based on different companies providing the service. The phone also transmits a registration request, and the network keeps track of the phone's location in a database (in this way, the MTSO identifies which cell the phone is in so that the phone can be contacted). As the phone moves between cells, the phone detects changes in the control channel's strength and re-registers itself with the new cell when it changes channels. If the phone cannot find any control channels to listen to, it knows it is out of range and displays a “no service” message.

Cellular phones can also operate using digital technology. Digital cell phones use the same radio technology (in different frequency bands—for example, PCS phones use frequencies between 1.85 and 1.99 gigahertz) but convert voice into digital 1s and 0s and then compress it. This compression allows between 3 and 10 cell phone calls to occupy the space of a single analog voice call. An analog channel is FM and is 30 kHz wide in order to provide acceptable voice quality). A digital channel (in TDMA-Time Division Multiple Access) is 30 kHz wide but is split time-wise into three time slots. Each conversation gets the radio for one-third of the time. Therefore, a digital channel has three times the capacity of an analog channel. Modulation and encoding schemes are used to do this and to maintain acceptable voice quality. Because of this, digital cell phones contain increased processing power. Analog signals, in comparison, cannot be compressed and manipulated as easily as a true digital signal.

PCS (Personal Communications Services) is a wireless phone service very similar to cellular phone service with an emphasis on personal service and extended mobility. The term “PCS” is also sometimes used in place of digital cellular, but true PCS means that other services like paging, caller ID and e-mail are bundled into the service. PCS has smaller cells and therefore requires a larger number of antennas to cover a geographic area.

Cellular systems in the United States operate in the 824-849 megahertz (MHz) frequency bands; PCS operates in the 1850-1990 MHz bands. Digital (TDMA) has 30 kHz channel spacing and three time slots. PCS has 200 kHz channel spacing and eight time slots.

Several technologies are used for PCS in the United States, including Cellular Digital Packet Data (CDPD) and Global System for Mobile (GSM) communication. GSM is more commonly used in Europe and outside the United States.

TDMA is a technology used in digital cellular telephone communication to divide each cellular channel into three time slots in order to increase the amount of data that can be carried. TDMA is used by Digital-American Mobile Phone Service (D-AMPS), Global System for Mobile communications (GSM), and Personal Digital Cellular (PDC). However, each of these systems implements TDMA in a somewhat different and incompatible way.

TDMA was first specified as a standard in EIA/TIA Interim Standard 54 (IS-54). IS-136, an evolved version of IS-54, is the U.S. standard for TDMA for both the cellular (850 MHz) and PCS (1.9 GHz) spectrums. TDMA is also used for Digital Enhanced Cordless Telecommunications (DECT).

CDMA (Code Division Multiple Access), one of the three wireless telephone transmission technologies, takes an entirely different approach from GSM and the similar TDMA. CDMA, after digitizing data, spreads it out over the entire bandwidth it has available. Multiple calls are overlaid over each other on the channel, with each assigned a unique sequence code.

TDMA uses narrow band signals, divided into different time slots—a certain number of users per a certain amount of spectrum. Narrow band means channelization in the traditional sense; for example, every 30 kHz is another channel. CDMA is a form of spread spectrum. All users transmit in the same wide-band spectrum space. Each user's signal is spread over the entire bandwidth by a unique spreading code. At the receiver, that same unique code is used to recover the signal. Ideally, TDMA and CDMA are transparent to each other.

Their mobility makes mobile telephones an important piece of emergency equipment. If the user experiences mechanical problems with his automobile, health problems, or needs to contact police or fire departments, he can use this mobile telephone to contact help. The user may store the phone numbers for police, fire, hospitals, and auto service in the phone directory within the mobile telephone.

Phone number information traditionally stored by the user is static. When the user is traveling, the static numbers stored in his telephone likely do not correspond with the local police, fire, hospital, and auto service for the travel location.

What is needed, therefore, is a way to provide a dynamic local phone directory to the user that changes when the user changes locations.

### SUMMARY

It has been discovered that a dynamic local phone directory can be provided to a mobile telephone. As the telephone moves from one area to another, dynamic directory information is sent from the telephone company to the mobile telephone. Emergency contact information, such as local police, fire, hospital, and auto service, can be downloaded to the telephone and stored in a dynamic directory. When the telephone moves to another mobile telephone area (such as another cell), different local contact information is automatically downloaded to the mobile telephone.

In one embodiment, the user provides preferences regarding the dynamic local information he wishes to download. For example, the user can indicate a language preference so that if different phone numbers are provided for different languages, the preferred phone number is delivered to the user. In addition, the user can indicate other factors, such as his insurance company or HMO, so that organizations matching the preferences are provided before organizations that do not match the preferences.

In another embodiment, the phone company provides a data packet of all local directory information available in the local area. The mobile telephone unit receives the information and filters the information based on the user's preferences. In another embodiment, the mobile telephone provides the phone company with the user's preferences and the phone company responds by sending matching information to the user's mobile telephone.

The mobile telephone also includes speed dial keys that are assigned to frequently used telephone numbers. Dynamic speed dial keys are used to assign dynamic telephone numbers, such as the police phone number, to a user preferred key. For example, if the user selected that speed dial key “2” should be assigned to “police,” then the “2” dynamic speed dial key would always correspond with the local police phone number. Dynamic speed dial keys can be maintained and stored along with static speed dial keys.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a block diagram of a mobile telephone using dynamic directories;

FIG. 2 is an external diagram of a mobile telephone using dynamic directories;

FIG. 3 is a diagram showing a user moving between mobile telephone areas and corresponding dynamic directory information being provided to the mobile telephone;

FIG. 4 is a flowchart of dynamic directory information being downloaded to a mobile telephone and filtered within the mobile telephone;

FIG. 5 is a flowchart of preferred dynamic directory information being downloaded to a mobile telephone in response to the mobile telephone sending preference information to the phone company; and

FIG. 6 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

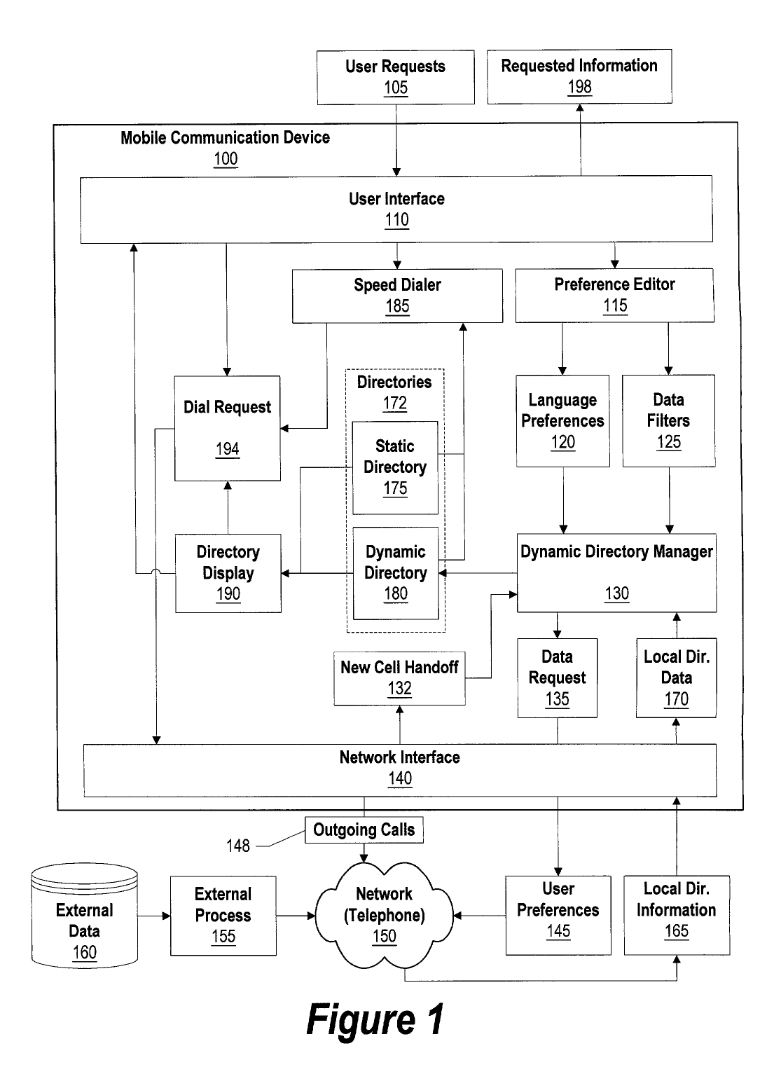

FIG. 1 shows a block diagram of a mobile telephone using dynamic directories. Mobile communications device 100, such as a mobile or cellular telephone, includes components and functions for providing dynamic directory information to the user. User requests 105 are received from the user by user interface 110. User interface 110 can include key entry, selections using a selection device (such as a thumb wheel), and voice recognition software for recognizing user requests 105 in the form of voice commands. Preference editor 115 is used to add, modify, and delete user preferences such as language preferences 120 and data filters 125. Language preferences 120 is used to store languages in which the user is fluent or understands. This information is used to select local phone directory numbers that correspond (if possible) with the user's language preference. If the user speaks Spanish but not English, language preference 120 would so indicate in order to connect the user with a Spanish speaking number if available. Data filters 125 are used to store additional information about user preferences. For example, if a user is a member of a particular HMO or is covered by a particular form of insurance, data filters 125 can capture the information for matching the user with appropriate services. In the insurance example, the phone number of hospitals that accept the user's insurance may be preferred over hospitals that do not accept the insurance. In addition, travel services, such as AAA, often affiliate with local auto service companies. If the user is a member of the travel service, he may prefer to identify and download those auto service companies that are affiliated with the travel service. Another example may be a user that has a particular medication need. He may wish to identify pharmacies that carry the needed medication. Dynamic directory manager 130 manages dynamic directory 180. When the user enters a new mobile telephone area, or cell, new cell handoff 132 receives control information from the new cell. New cell handoff 132 signals dynamic directory manager 130 to initiate updating dynamic directory 180. Dynamic directory manager 130 prepares data request 135. In one embodiment, data request 135 includes preference information 145 so that the telephone company responds with area data matching the user's preferences. In another embodiment, the telephone company provides all available telephone directory information and dynamic directory manager 130 filters the incoming data using language preferences 120 and data filters 125 to prepare dynamic directory 180.

Mobile telephone network 150 receives data request 135. External process 155 is performed at the Mobile Telephone Switching Office (MTSO), mobile telephone base station, or other telephone network location. External process 155 provides local telephone directory information based on the location of mobile communication device 100. The location of mobile communication device 100 is determined by identifying which base station is communicating with the device. In a cellular environment, this determination may be made by the MTSO coordinating the handoff between base stations. External process 155 reads external data 160 that includes local phone directory information. External data 160 may also include other information, such as the language spoken and preference matching information, such as which medical insurance a particular hospital accepts and which travel services are affiliated with a particular auto service company. External process 155 looks up requested local directory information and passes the data back through mobile telephone network 150. Local directory information 165 is received by network interface 140 operating within mobile communication device 100. Network interface 140 identifies the received information as local directory data 170 based on a control channel used for the communication or based upon a header or other control information included with the transmission. Area data 170 is received by dynamic directory manager 130 which processes the data and stores the filtered data in dynamic directory 180. Dynamic directory 180 and static directory 175 are included in directories 172. Directories 172 are stored within mobile communication device 100. Static directory 175 stores static phone numbers and other information the user enters. For example, the user may wish to store his home telephone number within static directory 175.

When the user wishes to use either static directory 175 or dynamic directory 180, he uses user interface 110 to access the information. Speed dialer 185 maps key combinations to phone numbers stored within static directory 175 and dynamic directory 180. For example, the user may have a speed dial set so that when he enters “#” followed by a “1” his home phone is called. In addition, dynamic directory numbers can be mapped. For example, when the user enters “#” followed by a “2” he may be connected with the local police department that is stored in dynamic directory 180. In one embodiment, a key is provided to access either static directory speed dials or dynamic directory speed dials. The user can also access directory information by using user interface 110 to show directory display 190. Directory display 190 can show either static directory 175, dynamic directory 180, or a combination of directory information.

When the user wishes to place a call, he uses user interface 110 to access dial request 194. Dial request 194 can receive phone numbers to dial from the user as entered on the keypad, from speed dialer 185 (which dials either a static or dynamic directory phone number), or as selected by the user from directory display 190. Dial request 194 sends the requested phone number to mobile telephone network 150 through network interface 140. Requested information 198 is returned to the user in the form of a connected phone call or display information showing the user directory information or preference information.

In addition, if the user wishes to retain one or more entries from dynamic directory 180, he can move the desired entries to static directory 175. For example, when the user moves to a new area, he may wish to freeze the local directory information in his mobile telephone so that the information is not lost when he travels away from his new home.

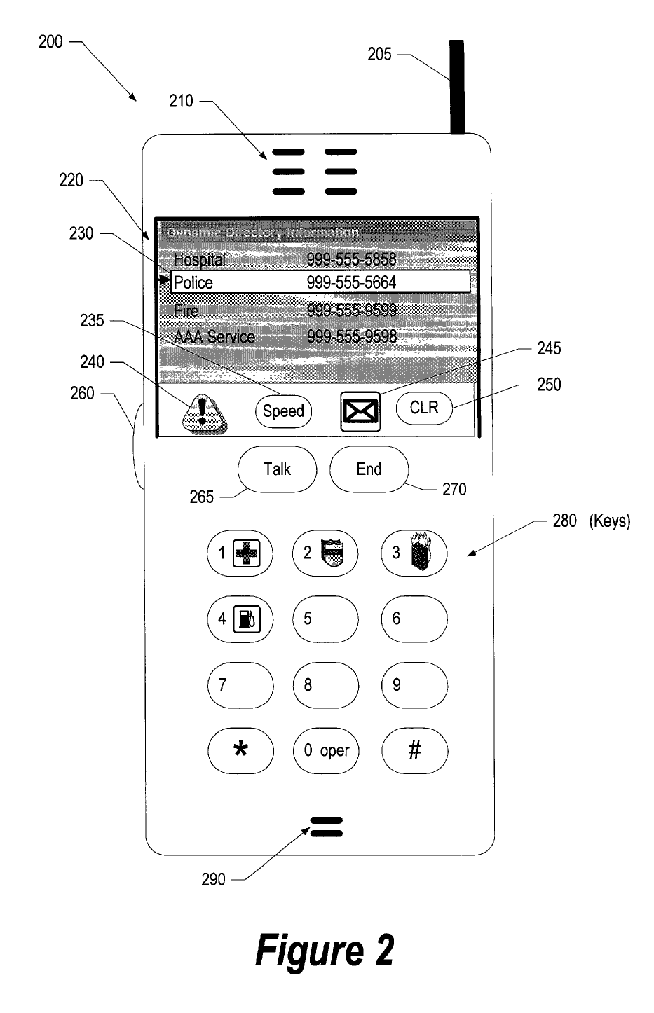

FIG. 2 shows an external diagram of a mobile telephone using dynamic directories. Mobile telephone 200 includes antenna 205 used to send and receive wireless signals to and from a mobile telephone network. Mobile telephone 200 also includes speaker 210 used to produce audible sounds received from a phone connection and microphone 290 used to receive the user's voice for voice commands and transmission to the mobile telephone network.

Mobile telephone 200 also includes display screen 220 used to display information to the user. In the example shown, dynamic directory information is shown in display screen 220. In the example shown, the dynamic directory information includes the hospital, police, fire department, and AAA auto service. Each of the dynamic directory items include a local telephone number used to connect to the corresponding dynamic entity. The user can use a selecting device, such as thumb selector 260, to scroll through and select a particular dynamic directory entry. In the example shown, local police phone number 230 has been selected.

Control buttons are used to perform certain mobile telephone functions. Speed dial button 235 is used in conjunction with one or more keypad numbers 280 to connect to a static directory speed dial number. For example, if the user programmed his home phone number to be speed dial “1” he would press speed dial button 235 followed by the “1” key followed by talk button 265. Emergency speed dial button 240 is used in conjunction with one or more keypad numbers to connect to a dynamic directory speed dial number. For example, if the user programmed that local hospital service be emergency speed dial “1” he would press emergency speed dial button 240 followed by the “1” key. In some embodiments, emergency speed dial numbers would automatically be dialed in response to emergency speed dial button 240 and a single digit pressed from the keypad. In another embodiment, the user would press talk button 265 after pressing emergency speed dial button 240 and one or more digits. When contacting numbers through either speed dial 235 or emergency speed dial 240, display 220 would display the name of the person or organization being contacted (e.g., “Mercy Hospital”) along with the phone number being dialed. In this way, the user can make certain that the correct phone number is being dialed. Voice mail button 245 is used to access voice mail provided by the mobile telephone company to retrieve messages for calls that the user did not answer or receive. Clear command button 250 is used to clear any number or menu entered or selected by the user in display area 220. Talk button 265 is used to connect to phone numbers entered or selected by the user in display area 220 or selected by the user using a speed dial function. End button 270 is used to terminate, or hang up, when a phone conversation is over. Thumb selector 260 is used to select among menu items or phone numbers displayed on display screen 220. In some embodiments, thumb selector 260 is rotated to scroll through selections and pressed to make a selection. Numeric keys 280 are used to enter phone numbers. In the example shown, labels have been applied to certain keys to indicate dynamic speed dial functions. Dynamic speed dial key “1” corresponds to a local hospital, dynamic speed dial key “2” corresponds to the local police, dynamic speed dial key “3” corresponds to the local fire department, and dynamic speed dial key “4” corresponds to a local auto service company.

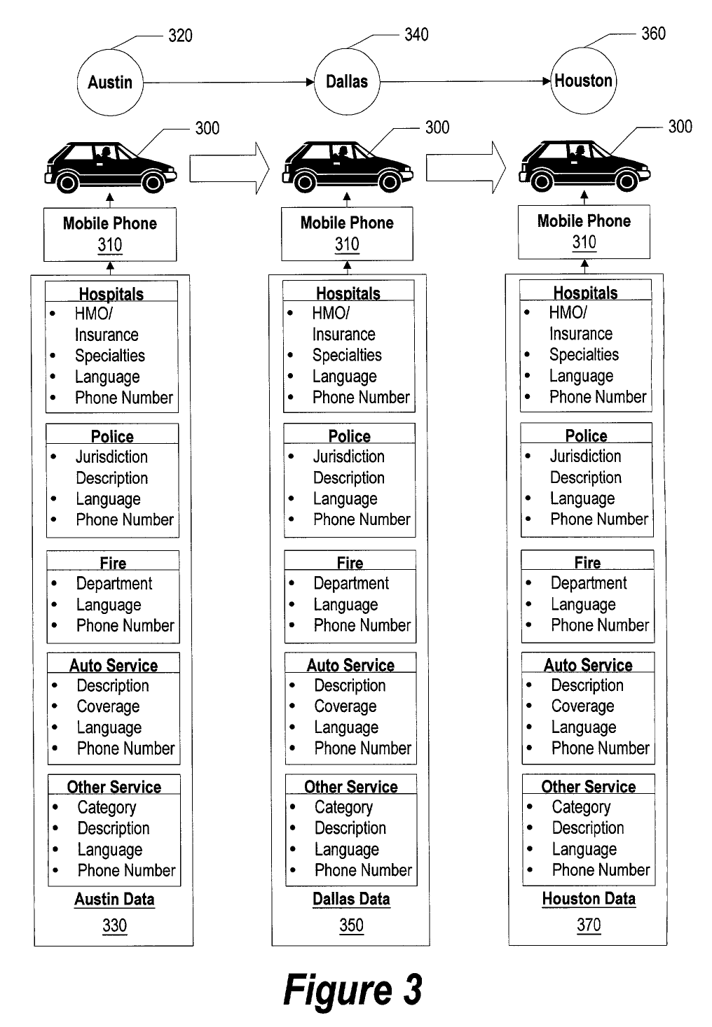

FIG. 3 shows a diagram of a user moving between mobile telephone areas and corresponding dynamic directory information being provided to the mobile telephone. User 300 is traveling between various cities in Texas. When the user is in Austin area 320, mobile telephone 310 contacts the mobile telephone company and receives Austin data 330 that includes Austin local directory information. Likewise, when user 300 travels to Dallas area 340, mobile telephone 310 contacts the mobile telephone company and receives Dallas data 350 that includes Dallas local directory information. Likewise, when user 300 travels to Houston area 360, mobile telephone 310 receives Houston data 370 from the mobile telephone company. In some implementations, such as a cellular network, the user may pass through several base stations and receive local directory information when a handoff is made between one base station and the next. The actual downloaded data may or may not change based upon the services provided in the newly entered cell.

The local directory information received at each location is both dynamic and flexible based upon the user's preferences and the services available in a given area. In the example of local directory information shown, hospital information includes information about the HMOs or insurance accepted by the hospital. Hospital information also includes a language for each phone number provided for the hospital. If the user prefers Spanish, the hospital phone number with a Spanish language option will be selected before a phone number without Spanish. Other information, such as specialties provided by the hospital, can also be included with hospital information. If a user has a heart condition he may wish to be connected with a hospital with a cardiac unit or specialty. Finally, one or more phone numbers for the hospital are provided.

In the police example, information may include the jurisdiction description—for example whether the number is for a county sheriff or a city police department. Police information also includes a language for each phone number provided for the police station. Other information, such as whether the phone number is for emergency or non-emergency calls can also be provided. Finally, one or more phone numbers for the local police department are provided.

In the fire department example, information may include the fire department—for example, the name or number of the fire station. Fire department information also includes a language for each phone number provided for the fire department. Other information, such as whether the phone number is for emergency or non-emergency calls can also be provided. Finally, one or more phone numbers for the local fire department are provided.

In the auto service example, information may include the description of the auto service—for example, the name and address of the auto service company. A coverage option is also included for any travel service affiliations, such as AAA, with which the auto service company is affiliated. If the user is a member of AAA and has entered this preference in mobile phone 310, then those auto service companies affiliated with AAA are selected before other service companies. Service company information also includes a language for each phone number provided for the service company. Finally, one or more phone numbers for the local auto service company are provided.

The “other service” category is used for any other local directory information that the user has requested. For example, if the user has a need for a certain type of medicine then local pharmacies providing the medication can be provided in the dynamic directory information. In addition, if the user is a member of a national club or organization, such as a health club, the mobile telephone can be instructed to download the name, address, and telephone number of any local clubs or offices. The category information can be used to select “pharmacies” or “health clubs” or other available categories. The description can be used to match a particular name or a pharmacy or health club or for other matching information such as the name of a particular type of medication. Downloaded information also includes a language for each phone number provided for the local service. Finally, one or more phone numbers for the local service are provided.

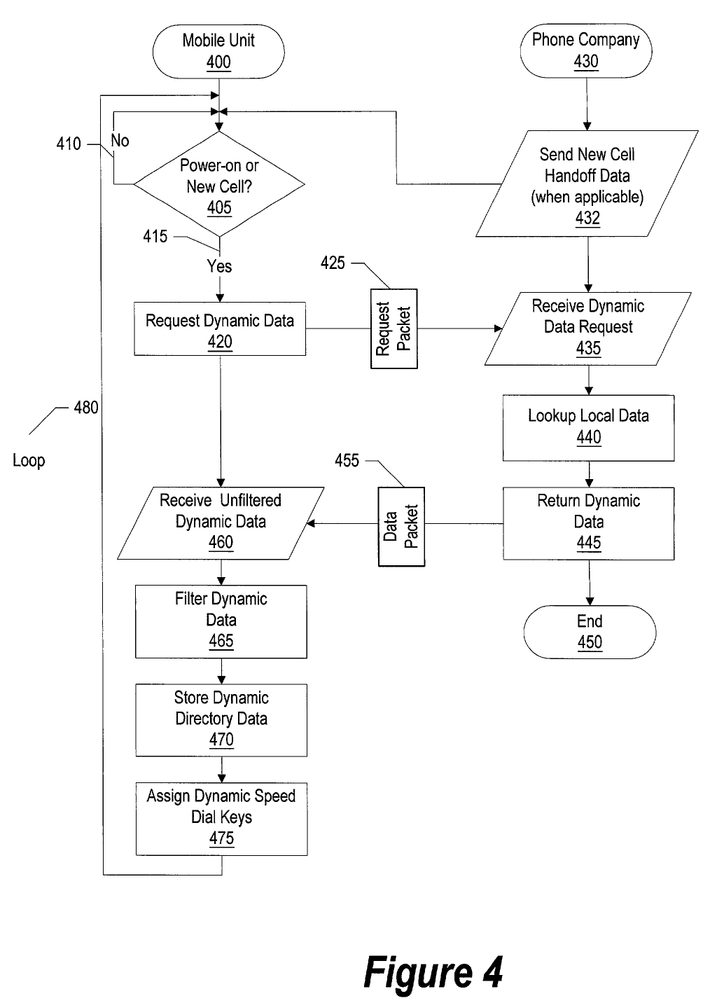

FIG. 4 shows a flowchart of dynamic directory information being downloaded to a mobile telephone and filtered within the mobile telephone. Mobile unit processing commences at 400 whereupon it checks whether the phone has been powered on or has entered a new cell (decision 405). If the phone has not powered on or entered a new cell, decision 405 branches to “no” branch 410 which loops until the phone enters a new cell. If the phone has just been turned on or entered a new cell, decision 405 branches to “yes” branch 415 whereupon a request is made to the mobile telephone network for dynamic directory data (step 420). Wireless request packet 425 is sent to the mobile telephone network. Phone company processing commences at 430. Whenever the user's mobile telephone enters a new cell, a handoff procedure takes place within the mobile telephone network to connect the user's mobile telephone with the appropriate base station. Whenever this handoff occurs, a signal is sent from the mobile telephone company to the mobile telephone (output 432). Phone company processing receives the dynamic data request from the user's mobile telephone (input 435). The mobile telephone company retrieves local area information for the area which the user has entered (step 440) and returns the dynamic data to the user (step 445). Mobile phone company processing ends at end 450.

Wireless data packet 455 contains the dynamic data retrieved in step 440. Mobile telephone receives wireless data packet 455 (input 460). Wireless data packet 455 contains all available local information including data such as language information, descriptions, and the like. The mobile telephone filters this information using the preferences entered by the user (step 465). The filtered data is then stored in the dynamic directory storage area (step 470) and dynamic speed dial keys are assigned to dynamic directory information as preferred by the user (step 475). Dynamic directory data is now accessible to the user through speed dial keys or the mobile telephone display. Processing then loops back (loop 480) to wait until the mobile phone enters a new cell.

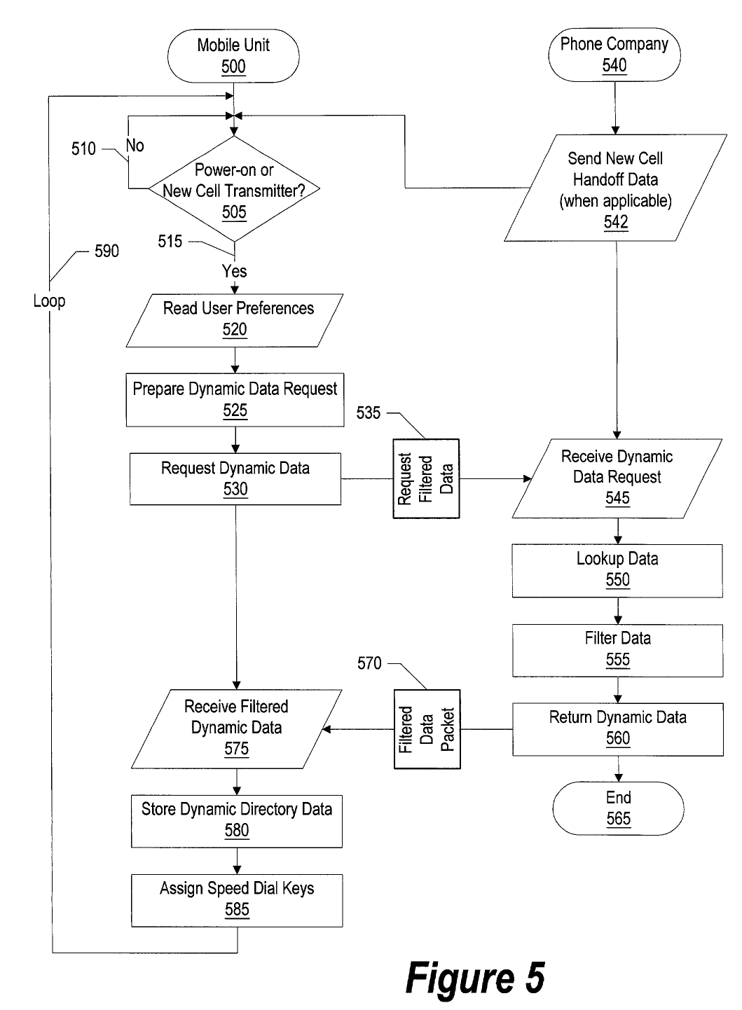

FIG. 5 shows a flowchart of preferred dynamic directory information being downloaded to a mobile telephone in response to the mobile telephone sending preference information to the phone company along with the dynamic data request. Mobile unit processing commences at 500 whereupon it checks whether the phone has been powered on or has entered a new cell (decision 505). If the phone has not powered on or entered a new cell, decision 505 branches to “no” branch 510 which loops until the phone enters a new cell. If the phone has just been turned on or entered a new cell, decision 505 branches to “yes” branch 515 whereupon the user's dynamic directory preferences are read (input 520). A dynamic data request is prepared using the user's preferences (step 525). The dynamic data request is then sent to the mobile telephone company (step 530). Wireless request for filtered data packet 535 is transmitted to the mobile telephone company network.

Mobile telephone company processing commences at 540. Whenever the user's mobile telephone enters a new cell, a handoff procedure takes place within the mobile telephone network to connect the user's mobile telephone with the appropriate base station. Whenever this handoff occurs, a signal is sent from the mobile telephone company to the mobile telephone (output 542). Phone company processing continues whereupon the user's request for dynamic data is received (input 545). The data requested by the user is retrieved (step 550) and filtered (step 555) using the filtering parameters provided by the user. The filtered data is then returned to the user over the mobile telephone network (step 560). Mobile telephone company processing ends at end 565. Because the filtering is performed by the mobile telephone network, the resulting filtered data packet 570 should be smaller than a corresponding data packet where the mobile telephone filters the data (see FIG. 4).

The mobile telephone receives the filtered dynamic data (input 575) and stores the data in the dynamic directory storage area (step 580). Dynamic speed dial keys are assigned to dynamic directory information as preferred by the user (step 585). Dynamic directory data is now accessible to the user through speed dial keys or the mobile telephone display. Processing then loops back (loop 590) to wait until the mobile phone enters a new cell.

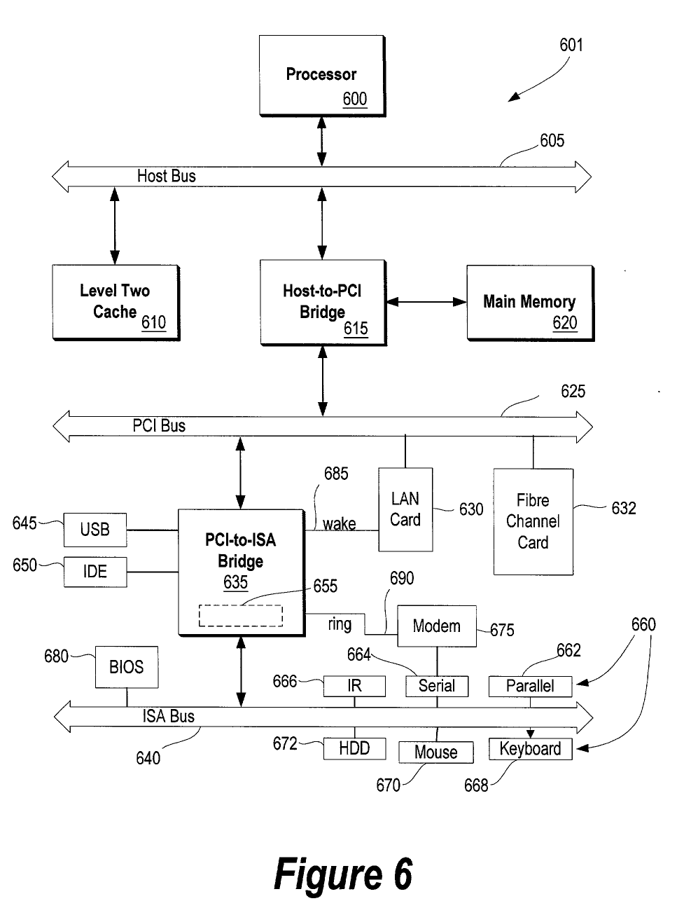

FIG. 6 illustrates information handling system 601 which is a simplified example of a computer system capable of performing the mobile telephone company operations. Computer system 601 includes processor 600 which is coupled to host bus 605. A level two (L2) cache memory 610 is also coupled to the host bus 605. Host-to-PCI bridge 615 is coupled to main memory 620, includes cache memory and main memory control functions, and provides bus control to handle transfers among PCI bus 625, processor 600, L2 cache 610, main memory 620, and host bus 605. PCI bus 625 provides an interface for a variety of devices including, for example, LAN card 630. PCI-to-ISA bridge 635 provides bus control to handle transfers between PCI bus 625 and ISA bus 640, universal serial bus (USB) functionality 645, IDE device functionality 650, power management functionality 655, and can include other functional elements not shown, such as a real-time clock (RTC), DMA control, interrupt support, and system management bus support. Peripheral devices and input/output (I/O) devices can be attached to various interfaces 660 (e.g., parallel interface 662, serial interface 664, infrared (IR) interface 666, keyboard interface 668, mouse interface 670, and fixed disk (HDD) 672) coupled to ISA bus 640. Alternatively, many I/O devices can be accommodated by a super I/O controller (not shown) attached to ISA bus 640.

BIOS 680 is coupled to ISA bus 640, and incorporates the necessary processor executable code for a variety of low-level system functions and system boot functions. BIOS 680 can be stored in any computer readable medium, including magnetic storage media, optical storage media, flash memory, random access memory, read only memory, and communications media conveying signals encoding the instructions (e.g., signals from a network). In order to attach computer system 601 to another computer system to copy files over a network, LAN card 630 is coupled to PCI bus 625 and to PCI-to-ISA bridge 635. Similarly, to connect computer system 601 to an ISP to connect to the Internet using a telephone line connection, modem 675 is connected to serial port 664 and PCI-to-ISA Bridge 635.

While the computer system described in FIG. 6 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of providing dynamic telephone directories to a mobile telephone, said method comprising:
identifying when the mobile telephone enters a mobile telephone area;
receiving one or more local telephone numbers corresponding to the mobile telephone area; and
storing the local telephone numbers in the mobile telephone.

2. The method as described in claim 1 further comprising:
filtering the local telephone numbers, the filtering based upon one or more user preferences stored in the mobile telephone, wherein the filtering is performed at the mobile telephone.

3. The method as described in claim 2 wherein the user preferences include a language preference.

4. The method as described in claim 1 further comprising:
filtering the local telephone numbers, the filtering based upon one or more user preferences stored in the mobile telephone, wherein the filtering is performed at a telephone company computer.

5. The method as described in claim 4 wherein the user preferences include a language preference.

6. The method as described in claim 1 further comprising:
assigning one or more dynamic speed dial keys to the local telephone numbers.

7. The method as described in claim 1 further comprising:
displaying the local telephone numbers on a display area included in the mobile telephone.

8. The method as described in claim 7 wherein each of the local telephone numbers includes a description, the method further comprising:
displaying the description corresponding with each local telephone number on the display area.

9. The method as described in claim 1 further comprising:
removing a prior set of local telephone numbers from a dynamic phone directory included in the mobile telephone;
wherein the storing further includes:
storing the local telephone numbers in the dynamic phone directory.

10. The method as described in claim 1 wherein the receiving and storing are performed in response to powering on the mobile telephone.

11. The method as described in claim 1 further comprising:
assigning one or more dynamic speed dial keys to the local telephone numbers.

12. A mobile telephone comprising:
one or more processors;
a memory accessible by the processors;
a wireless interface for communicating with a mobile telephone network;
a nonvolatile storage device accessible by the processors; and
a dynamic directory tool, the dynamic directory tool including:
means for identifying when the mobile telephone enters a mobile telephone area;
means for receiving one or more local telephone numbers corresponding to the mobile telephone area; and
means for storing the local telephone numbers in the mobile telephone.

13. The mobile telephone as described in claim 12 further comprising:
means for filtering the local telephone numbers, the filtering based upon one or more user preferences stored in the mobile telephone, wherein the filtering is performed at the mobile telephone.

14. The mobile telephone as described in claim 13 wherein the user preferences include a language preference.

15. The mobile telephone as described in claim 12 further comprising:
means for filtering the local telephone numbers, the filtering based upon one or more user preferences stored in the mobile telephone, wherein the filtering is performed at a telephone company computer.

16. The mobile telephone as described in claim 15 wherein the user preferences include a language preference.

17. The mobile telephone as described in claim 12 further comprising:
means for assigning one or more dynamic speed dial keys to the local telephone numbers.

18. The mobile telephone as described in claim 12 further comprising:
means for displaying the local telephone numbers on a display area included in the mobile telephone.

19. The mobile telephone as described in claim 18 wherein each of the local telephone numbers includes a description, the mobile telephone further comprising:
means for displaying the description corresponding with each local telephone number on the display area.

20. The mobile telephone as described in claim 12 further comprising:
means for removing a prior set of local telephone numbers from a dynamic phone directory included in the mobile telephone;
wherein the means for storing further includes:
means for storing the local telephone numbers in the dynamic phone directory.

21. The mobile telephone as described in claim 12 wherein the means for receiving and means for storing are performed in response to powering on the mobile telephone.

22. A computer program product of providing dynamic telephone directories to a mobile telephone, said computer program product comprising:
means for identifying when the mobile telephone enters a mobile telephone area;
means for receiving one or more local telephone numbers corresponding to the mobile telephone area; and
means for storing the local telephone numbers in the mobile telephone.

23. The computer program product as described in claim 22 further comprising:
means for filtering the local telephone numbers, the filtering based upon one or more user preferences stored in the mobile telephone, wherein the filtering is performed at the mobile telephone.

24. The computer program product as described in claim 22 further comprising:
means for filtering the local telephone numbers, the filtering based upon one or more user preferences stored in the mobile telephone, wherein the filtering is performed at a telephone company computer.

25. The computer program product as described in claim 22 further comprising:
means for assigning one or more dynamic speed dial keys to the local telephone numbers.

26. The computer program product as described in claim 22 further comprising:
displaying the local telephone numbers on a display area included in the mobile telephone.

27. The computer program product as described in claim 26 wherein each of the local telephone numbers includes a description, the computer program product further comprising:
means for displaying the description corresponding with each local telephone number on the display area.

28. The computer program product as described in claim 22 further comprising:
means for removing a prior set of local telephone numbers from a dynamic phone directory included in the mobile telephone;
wherein the means for storing further includes:
means for storing the local telephone numbers in the dynamic phone directory.
